(19) United States
(12) Patent Application Publication
(10) Pub. No.: US 2025/0334228 A1
(43) Pub. Date: Oct. 30, 2025

(54) COMPOSITE SHEET STOCK BARRIER MATERIAL FOR THE FORMING OF PRESSURE VESSEL TUBULAR CORE WITH SIGNIFICANTLY ELEVATED HYDROGEN PERMEATION RESISTANCE

(71) Applicant: BRAINDRIP, LLC, JACKSONVILLE, FL (US)

(72) Inventor: Kent Weisenberg, Jacksonville, FL (US)

(73) Assignee: BRAINDRIP, LLC, JACKSONVILLE, FL (US)

(21) Appl. No.: 19/188,737

(22) Filed: Apr. 24, 2025

Related U.S. Application Data
(60) Provisional application No. 63/638,478, filed on Apr. 25, 2024.

(51) Int. Cl. F17C 1/16; B32B 9/00; B32B 15/085; B32B 15/088; B32B 27/18; B32B 27/32; B32B 27/34; B32B 37/15

(52) U.S. Cl. CPC F17C 1/16; B32B 9/007; B32B 15/085; B32B 15/088; B32B 27/18; B32B 27/32; B32B 27/34; B32B 37/153; B32B 2250/03; B32B 2264/1022; B32B 2264/1023; B32B 2307/7376; B32B 2597/00; F17C 2201/0104; F17C 2203/0621; F17C 2203/0636; F17C 2203/066; F17C 2209/221; F17C 2209/232

(57) ABSTRACT

Sealed vessels for the storage and/or transmission of gases, including hydrogen, over prolonged periods of time with minimal loss due to escape of gas. A Iso provided herein are related methods of manufacture and methods of storage of gas. A Iso provided herein are related methods of manufacture and methods of transmission of gas.

### CROSS REFERENCE TO RELATED APPLICATIONS

This application claims priority to U.S. Provisional Patent Application Ser. No. 63/638,478, filed on Apr. 25, 2024, and titled “Composite Sheet Stock Barrier Material for the Forming of Pressure Vessel Tubular Core with Significantly Elevated Hydrogen Permeation Resistance,” the disclosure of which is incorporated herein by reference.

### FIELD

Disclosed herein are materials and related methods for improving the resistance of vessels to permeation by gases, including, but not limited to, hydrogen. Also disclosed herein are sealed vessels for the storage and/or transmission of gases, including hydrogen, over prolonged periods of time with minimal loss due to the escape of gas.

### BACKGROUND

The use of sealed vessels is widespread in industry for storage and transmission of gases. Ideally, a sealed vessel used to contain a gas is completely impermeable to the gas, and leakage of gas from the vessel is entirely eliminated. Storage of hydrogen is particularly susceptible to leakage, due to the small size of the diatomic molecule (H₂), compared to hydrocarbons. The diatomic hydrogen molecule is significantly smaller than even methane, the simplest hydrocarbon. A side from loss of product, permeation of hydrogen from a sealed vessel can potentially create hazard, due to its high flammability. For this reason, materials and methods are sought to reduce hydrogen permeation from sealed vessels, particularly for extended periods of time.

Certain materials, such as high-density polyethylene (HDPE), are employed in sealed vessels to minimize loss of gas, particularly hydrogen. Although pristine HDPE shows adequate resistance to permeation by hydrogen, the long-term durability of this material, particularly after exposure to hydrogen, remains uncertain. For example, chemical reaction with hydrogen may impact the mechanical or structural properties of this material. Finally, entrapment of gas, at pressure, in the structural base layer of the sealed vessel can lead to uncontrolled expansion of this entrapped gas if the sealed vessel is quickly vented (intentionally or not), leading to damage caused by the expanded gas within the structural base layer.

M any sealed vessels intended for hydrogen storage or transmission utilize an interior core material, such as a thermoplastic or metal, coated with an over-wrap of a tape or foil of hydrogen-resistant material. A drawback for this design is that hydrogen is in contact with the interior core material and will diffuse into it. Over time, this diffusion of hydrogen into the core material may compromise its mechanical or structural integrity. In turn, this reduced integrity may render the over-wrap susceptible to breaks or tears, thus defeating its function of preventing hydrogen leakage. In addition, any discontinuity in the over-wrap will create a path for permeation by hydrogen. In turn, the outflow of hydrogen at the site of discontinuity may aggravate the damage to the sealed vessel, leading to potential increased leakage and possible structural failure.

In many settings, the questionable durability of materials such as HDPE in face of long-term exposure to hydrogen is unacceptable. In certain settings, a sealed vessel must provide an extended service life, particularly if repair or re-installation of the vessel would be unduly costly or disruptive. A design that exposes the core material to hydrogen, even in small amounts, is unsatisfactory for these settings.

In some instances, the permeation of hydrogen through the vessel is unavoidable and deemed acceptable if under the regulated limits. The permeation of hydrogen however does create unwanted results. The permeation of hydrogen into the atmosphere is a loss of hydrogen and therefore becomes a continual and anticipated loss of revenue for the producer, thus increasing the cost to the consumer. Furthermore, while hydrogen permeation below the regulated limits is acceptable, the potential additional danger created from exhausting hydrogen requires the owner or operator of the vessel to increase the intensity of their risk management protocols, thus passing this additional cost of continually monitoring, assessing and addressing these additional risks to the consumer.

In some instances, the permeation of hydrogen through the vessel would further affect other functional layers in the material of the sealed vessel. M any materials used for the storage of gases are intrinsically resistant to hydrogen; however, certain materials, such as fiberglass, synthetics such as polyethylene or liquid crystal, and aramid, are susceptible to degradation from long term exposure to hydrogen. Furthermore, fiber optics, included in optional sensor mechanisms, can also be vulnerable to hydrogen gas, and can be made unusable from exposure. Due to this susceptibility, certain materials incorporated into the sealed vessel may benefit from further protection from hydrogen permeation, including, but not limited to reinforcement fibers and fiber optic sensor cables. There remains a need for sealed vessels that resist permeation of hydrogen and other gases over an extended period of time.

### BRIEF SUMMARY

Accordingly, provided herein is a sealed vessel providing prolonged resistance to permeation by gas, the sealed vessel comprising the following layers, arranged from exterior to interior:
a base layer comprising a base material;
a permeation resistant layer comprising a permeation resistant material; and
an optional sacrificial/protective layer comprising a sacrificial/protective material.

Location of the permeation resistant layer interior to the base layer will block permeation of a gas, including but not limited to hydrogen, from the interior of the sealed vessel into the vulnerable structural base layer, thereby prolonging the useful lifetime of the sealed vessel.

Incorporation of an innermost sacrificial/protective layer will protect the potentially fragile permeation resistant layer from potential damage during handling and vessel production as well as to prolonged or repeated exposure to potential erosion due to high flow velocities of the gas through the sealed vessel. In addition, by preventing hydrogen from entering the structural base layer, the possibility of damage from rapid depressurization is eliminated.

### BRIEF DESCRIPTION OF THE DRAWINGS

A full understanding of the invention can be gained from the following description of the preferred embodiments when read in conjunction with the accompanying drawings in which:

FIGS. 1 (a) And 1 (b) depict cross-sections of a material according to an exemplary embodiment of the disclosure; and

FIG. 2 depicts a cross section, in perspective, of a cylindrical sealed vessel according to an exemplary embodiment of the disclosure;

FIG. 3 depicts a cross section, in perspective, of a cylindrical sealed vessel, after application of a tape containing viscous filler material, according to an exemplary embodiment of the disclosure; and

FIG. 4 depicts an assembly for forming cylindrical tubes that includes a forming mandrel that may be used in a method of forming a cylindrical tube according to the disclosed concept.

### DETAILED DESCRIPTION OF PREFERRED EMBODIMENTS

Accordingly, provided herein is a composite sheet stock with improved resistance to permeation by gas, the composite sheet stock comprising:
a base layer comprising a base material;
a permeation resistant layer comprising a permeation resistant material; and
an optional sacrificial/protective layer comprising a sacrificial material.

The base layer can be composed of a base material that confers strength and durability to the sheet stock. In some embodiments, the base material comprises a thermoplastic or thermoset material. In some embodiments, the base material comprises a polyolefin or a polyamide. In some embodiments, the polyolefin is chosen from polyethylene, polypropylene, or a mixture thereof. In some embodiments, the polyamide is chosen from a nylon and an aramid. In some embodiments, the base material comprises polyethylene. In some embodiments, the base material comprises polyethylene chosen from HDPE, MDPE, or a mixture thereof.

In some embodiments, the base material further comprises a metal oxide. In some embodiments, the metal oxide is chosen from TiO₂ and Al₂O₃.

In some embodiments, the base material comprises a thermoplastic or thermoset material and a metal oxide. In some embodiments, the base material comprises a thermoplastic or thermoset material and a metal oxide. In some embodiments, the ratio (w/w) of metal oxide to polyolefin is about 10:1. In some embodiments, the ratio (w/w) of metal oxide to polyolefin is at most 100:1, optionally at most 50:1, optionally at most 20:1. In some embodiments, the ratio (w/w) of metal oxide to polyolefin is at least 1:4, optionally at least 1:2, optionally at least 1:1, optionally at least 2:1, optionally at least 5:1.

In some embodiments, the base material comprises a thermoplastic or thermoset material. In some embodiments, the base material comprises a polyolefin or a polyamide. In some embodiments, the base material comprises a polyolefin chosen from polyethylene, polypropylene, or a mixture thereof. In some embodiments, the base material comprises a polyamide chosen from a nylon and an aramid. In some embodiments, the base material comprises a polyolefin chosen from polyethylene, polypropylene, or a mixture thereof. In some embodiments, the base material comprises polyethylene. In some embodiments, the base material comprises polyethylene chosen from HDPE, MDPE, or a mixture thereof.

In some embodiments, the base material comprises a polyolefin or a polyamide. In some embodiments, the base material comprises a polyolefin chosen from polyethylene, polypropylene, or a mixture thereof. In some embodiments, the base material comprises a polyamide chosen from a nylon and an aramid. In some embodiments, the base material comprises a polyolefin chosen from polyethylene, polypropylene, or a mixture thereof. In some embodiments, the base material comprises polyethylene. In some embodiments, the base material comprises polyethylene chosen from HDPE, MDPE, or a mixture thereof.

In some embodiments, the thickness of the base layer is between 0.050 inches and 8 inches, inclusive. In some embodiments, the thickness of the base layer is between 0.060 inches and 6 inches, inclusive.

The permeation resistant layer can be composed of any material that blocks permeation of gas. In some embodiments, the gas is hydrogen. In some embodiments, the gas is methane. In some embodiments, the gas is CO₂. In some embodiments, the gas is an H₂/CH₄ blend. In some embodiments, the gas is sour gas. In some embodiments, the permeation resistant material is a foil. In some embodiments, the permeation resistant material comprises a metal or metal oxide, or a mixture thereof. In some embodiments, the metal is chosen from aluminum, copper, gold, and molybdenum, or a mixture thereof. In some embodiments, the metal oxide is alumina. In some embodiments, the permeation resistant material further comprises a hydrogen permeation resistant material. In some embodiments, the hydrogen permeation resistant material is chosen from W and SiC.

In some embodiments, the permeation resistant material is coextruded with the base material. In some embodiments, the permeation resistant material is bonded to the base material. In some embodiments, the permeation resistant material is thermally bonded to the base material.

In some embodiments, the thickness of the permeation resistant layer is between 0.002 inches and 0.50 inches, inclusive. In some embodiments, the thickness of the permeation resistant layer is between 0.002 inches and 0.02 inches, inclusive. In some embodiments, the thickness of the permeation resistant layer is between 0.025 inches and 0.125 inches, optionally between 0.050 and 0.15, inclusive.

In some embodiments, the thickness of the permeation resistant layer is at least 0.002 inches, optionally at least 0.005 inches, optionally at least 0.010 inches, optionally at least 0.025 inches, optionally at least 0.050 inches, optionally at least 0.100 inches, optionally at least 0.200 inches.

In some embodiments, the thickness of the permeation resistant layer is at most 0.500 inches, optionally at most 0.250 inches, optionally at most 0.100 inches, optionally at most 0.050 inches, optionally at most 0.020 inches, optionally at most 0.010 inches, optionally at most 0.050 inches.

In some embodiments, the composite sheet stock further comprises a protective or bonding material between the permeation resistant layer and the sacrificial/protective layer. In some embodiments, the protective or bonding material improves adherence between the permeation resistant layer and the sacrificial/protective layer.

In some embodiments:
the composite sheet stock does not contain a sacrificial/protective layer.

In some embodiments:
the composite sheet stock comprises a sacrificial/protective layer; and
the permeation resistant layer is located between the base layer and the sacrificial/protective layer.

The optional sacrificial/protective layer can be composed of any material that shields the permeation resistant layer from damage due to the velocity of gas within the sealed container, for example, during injection and withdrawal of gas. Due to its intended location on an interior wall of a sealed vessel, the material will bear the brunt of the damage caused by the gas. The sacrificial/protective layer may undergo ablation, tearing, or other damage which, while being harmful to this layer, will not impact the performance or robustness of the material as a whole. For this reason, the material that constitutes the sacrificial/protective layer is termed “sacrificial material” herein.

In some embodiments, the sacrificial material comprises a thermoplastic or thermoset material. In some embodiments, the sacrificial material comprises a polyolefin. In some embodiments, the sacrificial material comprises a polyolefin chosen from polyethylene, polypropylene, or a mixture thereof. In some embodiments, the sacrificial material comprises polyethylene. In some embodiments, the sacrificial material comprises MDPE.

In some embodiments, the thickness of the sacrificial/protective layer is between 0.001 inches and 0.050 inches, inclusive. In some embodiments, the thickness of the sacrificial/protective layer is between 0.020 inches and 0.5 inches, inclusive. In some embodiments, the thickness of the sacrificial/protective layer is at least 0.001 inches, optionally at least 0.002 inches, optionally at least 0.005 inches, optionally at least 0.010 inches, optionally at least 0.025 inches, optionally at least 0.050 inches, optionally at least 0.100 inches, optionally at least 0.200 inches.

In some embodiments, the thickness of the sacrificial/protective layer is at most 0.500 inches, optionally at most 0.250 inches, optionally at most 0.100 inches, optionally at most 0.050 inches, optionally at most 0.020 inches, optionally at most 0.010 inches, optionally at most 0.005 inches, optionally at most 0.002 inches.

In some embodiments, the sacrificial material further comprises an external layer of abrasion or permeation resistant material on the surface of the sacrificial/protective layer.

In some embodiments, the abrasion or permeation resistant material is used as a filler material during production of the thermoplastic or thermoset material. In some embodiments, the abrasion or permeation resistant material is laminated onto the thermoplastic or thermoset material. In some embodiments, the abrasion or permeation resistant material is coated onto the thermoplastic or thermoset material. In some embodiments, the abrasion or permeation resistant material is a foil comprising Au or Cu, or a combination thereof. In some embodiments, the abrasion or permeation resistant material is a carbide. In some embodiments, the abrasion or permeation resistant material is a silicon carbide. In some embodiments, the abrasion or permeation resistant material is beta-silicon carbide.

In some embodiments, the composite sheet stock comprises a coextrusion of a permeation resistant material as disclosed herein with a base material as disclosed herein. In some embodiments, the composite sheet stock comprises a laminate of a permeation resistant material as disclosed herein bonded to base material as disclosed herein. In some embodiments, the composite sheet stock comprises a laminate of a permeation resistant material as disclosed herein thermally bonded to base material as disclosed herein.

The composite sheet stock is provided with sufficient flexibility to allow bending into a tubular shape without damage. The inner diameter of tubes envisioned for this material can be 6 inches or smaller, up to 36 inches or larger. Generally, but not necessarily, the sheet stock will have sufficient rigidity so that joining the long ends of an extended rectangle of the material will form a substantially cylindrical tube.

In some embodiments, the composite sheet stock is provided in a length between 2 feet and 20,000 feet, inclusive. In some embodiments, the composite sheet stock is provided in a width between 6 inches and 12 feet, inclusive. In some embodiments, the composite sheet stock is provided on a spool.

In some embodiments, the composition of the composite sheet stock is uniform, in that all of the layers that constitute the sheet stock extend to the edges. In some embodiments, the permeation resistant layer and, when present, the sacrificial/protective layer are held back from the long edges of the sheet stock. In some embodiments, the base layer extends between 0.060 inches, or smaller, and 0.125 inches, or larger, at each of the long edges. The overhang of the base layer beyond the permeation resistant layer and optional sacrificial/protective layer can facilitate welding of the long edges, without interference from the permeation resistant layer or sacrificial/protective layer.

In some embodiments, the sheet stock is initially manufactured to provide the extension of the base layer beyond the permeation resistant layer and optional sacrificial/protective layer. In some embodiments, the permeation resistant layer and optional sacrificial/protective layer are trimmed, thereby providing the extension of base layer, subsequent to manufacture, optionally using an automated process.

In some embodiments,
the sheet stock is manufactured with the permeation layer and,
the base layer is welded with a material that comprises a highly permeation resistant material, thereby conferring permeation resistance to the weld.

Also provided herein is a sealed vessel comprising:
a shell comprising a composite sheet stock as disclosed herein;
an interior surface to the shell; and
an exterior surface to the shell.

In some embodiments, the sealed vessel is elongated in one dimension. In some embodiments, the sealed vessel is tubular. In some embodiments, the sealed vessel has cylindrical symmetry.

Also provided herein is a cylindrical tube comprising:
a shell comprising a composite sheet stock as disclosed herein;
an interior surface to the shell;
an exterior surface to the shell;
a first open end; and
a second open end.

In some embodiments of the sealed vessel or cylindrical tube, the base layer of the composite sheet stock is not located on the interior surface of the shell. In some embodiments of the sealed vessel or cylindrical tube, the base layer of the composite sheet stock is located on the exterior surface of the shell.

In some embodiments of the sealed vessel or cylindrical tube:
the composite sheet stock comprises a sacrificial/protective layer comprising a sacrificial material;
the sacrificial/protective layer is located on the interior surface of the shell.

In some embodiments, the sealed vessel or cylindrical further comprises a weld, formed during a process of bringing the long ends of the sheet stock together to form a shell. In some embodiments, the long ends of the sheet stock overlap each other at the site of the weld.

In some embodiments of the sealed vessel or cylindrical tube, the base layer extends beyond the permeation resistant layer and, when present, the optional sacrificial/protective layer, at the site of the weld. In some embodiments, the trough at the site of the weld due to the absence of permeation resistant layer and the optional sacrificial/protective layer is filled with a tape of viscous filler material, thereby providing resistance to permeation and, optionally, the protection from abrasion that would otherwise be afforded by the permeation resistant layer and the optional sacrificial/protective layer. In some embodiments, the tape comprises a highly permeation and abrasion resistant material. In some embodiments, the material is chosen from beta-silicon carbide, Al₂O₃, Al, Au, graphene, and Cu.

In some embodiments of the sealed vessel or cylindrical tube:
the composite sheet stock does not comprise the sacrificial/protective layer; and
the permeation resistant layer is located on the interior surface of the shell.

In some embodiments of the sealed vessel or cylindrical tube:
the sealed vessel comprises one or more strips of the composite sheet stock oriented lengthwise along the long axis of the sealed vessel.

In some embodiments of the sealed vessel or cylindrical tube:
the sealed vessel comprises a single strip of the composite sheet stock oriented lengthwise along the long axis of the sealed vessel.

In some embodiments of the sealed vessel or cylindrical tube:
the sealed vessel comprises one or more strips of the composite sheet stock oriented helically along the long axis of the sealed vessel.

In some embodiments of the sealed vessel or cylindrical tube:
the sealed vessel comprises a single strip of the composite sheet stock oriented helically along the long axis of the sealed vessel.

In some embodiments of the sealed vessel or cylindrical tube:
seams between adjacent edges of the one or more strips have been joined with a weld.

Also provided herein is a method for manufacturing a cylindrical tube as disclosed herein, the method comprising the steps of:
providing a mechanical forming mandrel having a fixed, upstream end and a cantilevered, downstream end;
providing a feedstock of a composite sheet stock as disclosed herein;
forming a circular leading end of the shell of the cylindrical tube from the feedstock on the surface of the mandrel at a first location near the fixed end;
advancing the circular leading end towards the cantilevered end;
progressively draping the feedstock onto the surface of the mandrel behind the advancing first circular end so that the base layer is oriented to the exterior of the growing cylindrical tube;
progressively joining the long ends of the feedstock draped on the surface of the mandrel, thereby forming a seam; and
progressively welding the seam, thereby providing a growing cylindrical tube;
severing, as needed, a finished cylindrical tube from the feedstock; and
separating the completed cylindrical tube from the cantilevered end.

In some embodiments, the base layer of the feedstock extends beyond the permeation resistant layer and, when present, the optional sacrificial/protective layer. In some embodiments, the method further comprises a step of applying a tape of highly permeation and abrasion resistant material as disclosed herein to the trough at the site of the weld due to the absence of permeation resistant layer and, when present, the sacrificial/protective layer.

In some embodiments, the method further comprises a step of inspecting the site of the weld from the interior of the cylindrical tube. In some embodiments, the inspection is performed using computer vision. In some embodiments, the inspection is performed using Al or machine learning.

Also provided herein is a method of manufacture for a sealed vessel as disclosed herein, the method comprising the steps of:
providing a cylindrical tube as disclosed herein;
providing a seal on the first open end of the cylindrical tube; and
providing a seal on the second open end of the cylindrical tube.

Also provided is a method for storing a gas with minimal loss due to escape, the method comprising the step of filling a sealed vessel as disclosed herein with the gas.

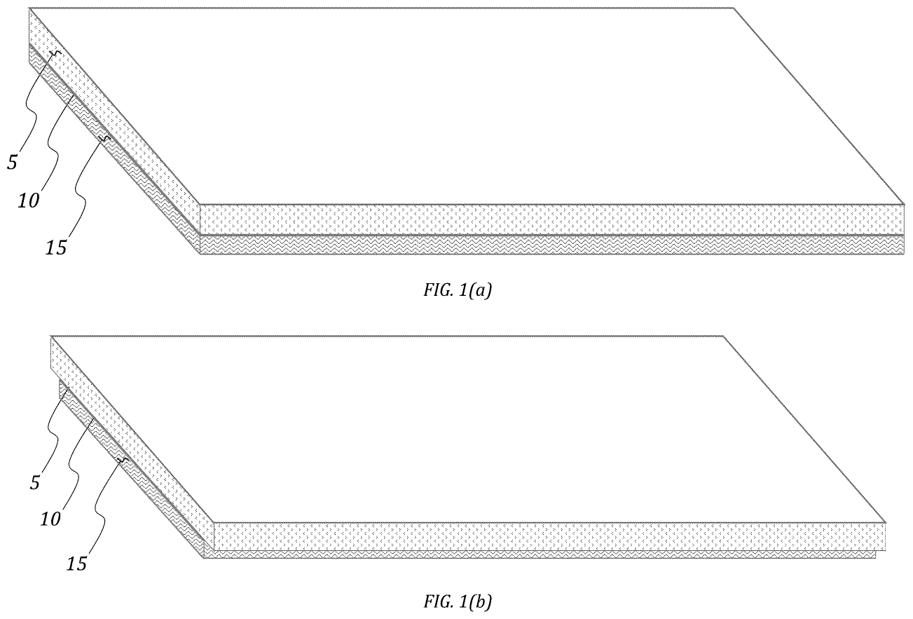

Depicted in FIG. 1 (a) is a cross-section of the sheet stock barrier material according to an exemplary embodiment of the disclosure. Dimensions of the various layers are not to scale. The front and back edges of the material of FIG. 1 (a) can be dropped and joined to form a cylindrical tube having a horizontal axis of symmetry, with a base layer 5 forming the exterior of the tube.

Base layer 5 includes a base material, Generally, the base material confers strength and durability to the sheet stock as a whole. In one embodiment, the base material of base layer 5 includes a thermoplastic or thermoset material, such as a polyolefin or polyamide. The polyolefin may be polyethylene, polypropylene, or a mixture thereof. The polyethylene may be HDPE, MDPE, or a mixture thereof. The polyamide may be nylon and an aramid. The base material may further include a metal oxide, such as TiO2 and Al2O3. In one particular embodiment, the thickness of the base layer 5 is between 0.060 inches and 6 inches, inclusive.

Permeation resistant layer 10 includes a permeation resistant material and is responsible for providing resistance to leakage by gas, particularly hydrogen. The permeation resistant material may be a foil, such as a metal foil or a metal oxide foil. The metal may be aluminum, copper, gold, molybdenum, or a mixture thereof. In one embodiment, the metal oxide is alumina. The permeation resistant layer 10 may be coextruded with the base layer 5. Alternatively, permeation resistant layer 10 may be bonded to the base layer 5. In one embodiment, the permeation resistant layer 10 is between 0.005 inches and 0.125 inches, inclusive.

Sacrificial/protective layer 15 comprises a sacrificial material and protects the potentially fragile permeation resistant layer 10 from damage caused by prolonged or repeated exposure to gas flow through the sealed vessel. The sacrificial material may include a thermoplastic or thermoset material. In one embodiment, the sacrificial material comprises a polyolefin. The polyolefin may be polyethylene, polypropylene, or a mixture thereof. In one embodiment, the sacrificial material comprises M DPE. In one embodiment, wherein the thickness of the sacrificial/protective layer 15 is between 0.020 inches and 0.050 inches, inclusive. The sacrificial/protective layer 15 may also include an external layer of abrasion or permeation resistant material on the sacrificial material on the external facing surface of the sacrificial/protective layer 15. The abrasion or permeation resistant material may be carbide, such as a silicon carbide like beta-silicon carbide.

Depicted in FIG. 1 (b) is a cross-section of the sheet stock barrier material according to another exemplary embodiment of the disclosure. The functionality of base layer 5, permeation resistant layer 10, and sacrificial/protective layer 15 remains the same as for the material of FIG. 1 (a). It will be noted that base layer 5 extends beyond permeation resistant layer 10 and sacrificial/protective layer 15 at the front and rear edges of the material

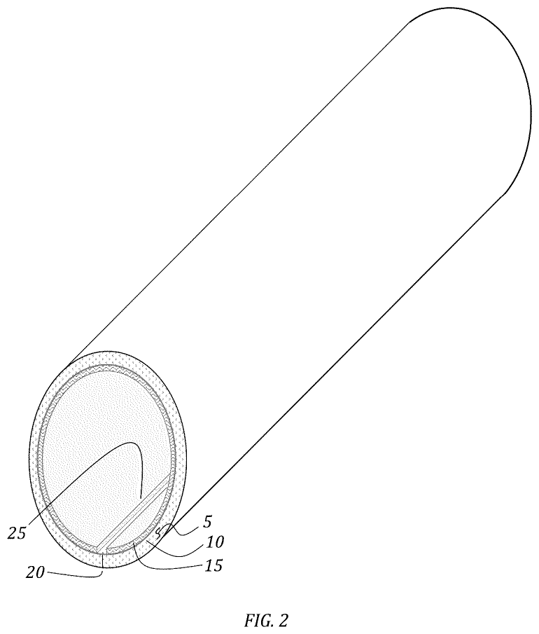

Depicted in FIG. 2 is a cross-section, in perspective, of a cylindrical tube formed from the material of FIG. 1 (b). Base layer 5, permeation resistant layer 10, and sacrificial/protective layer 15 are curved to form the cylinder, and the long edges of base layer 5 are joined to form seam 20. In this embodiment, permeation resistant layer 10 and sacrificial/protective layer 15 do not extend to the entirety of the inner circumference of the cylindrical tube, resulting in the formation of channel 25 between the longitudinal ends of layers 10 and 15. The presence of this channel 25 is a result of the mismatch in layer widths, which allows for the welding of base layer 5, forming seam 20 without interference from either of permeation resistant layer 10 and sacrificial/protective layer 15.

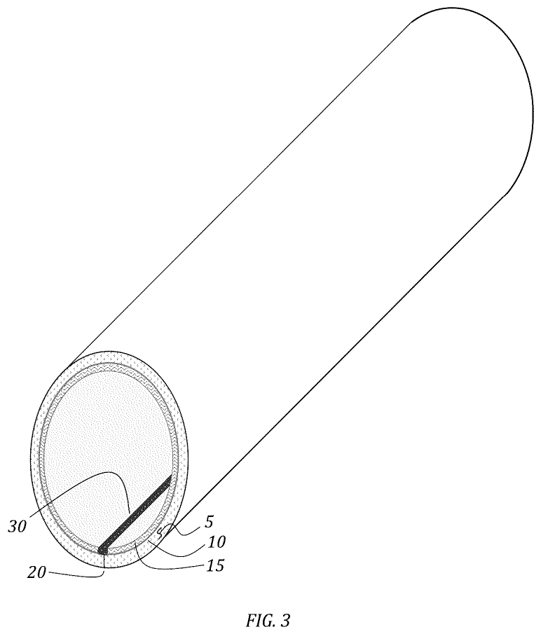

Depicted in FIG. 3 is a cross-section, in perspective, of the cylindrical tube of FIG. 2, after application of a tape 30, comprising viscous filler material. Tape 30 thereby fills channel 25, due to the intentional mismatch of layer widths, removing a possible location for leakage of gas to the exterior of the sealed vessel. Tape 30 comprises a material chosen from beta-silicon carbide, Al₂O₃, Al, Au, graphene, and Cu.

A further embodiment of the disclosed concept provides a method for manufacturing a cylindrical tube for transporting a gas, such as hydrogen. In the exemplary embodiment, the method includes providing a mechanical forming mandrel having a fixed, first end and a cantilevered, second end, and providing a feedstock of a composite sheet stock having first and second long ends extending in a longitudinal direction. The composite feed stock includes a base layer comprising a base material, a permeation resistant layer comprising a permeation resistant material for providing resistance to leakage of gas through the composite sheet stock, and a sacrificial/protective layer comprising a sacrificial material, wherein the permeation resistant layer is located between the base layer and the sacrificial/protective layer. The method further includes forming a circular leading end of the cylindrical tube from the composite sheet stock on a surface of the mandrel at a first location near the first end of the forming mandrel, advancing the circular leading end towards the second end of the forming mandrel, progressively draping the composite sheet stock onto the surface of the mandrel behind the advancing circular leading end so that the base layer is oriented on an exterior of the draped composite feed stock, and progressively forming a seam between the first and second long ends along the longitudinal axis while the composite sheet stock is draped onto the surface of the mandrel. The exemplary method also includes heating the composite feed stock while it is advanced and while it is progressively draped and while the seam is formed. The exemplary method also further includes progressively welding the seam, thereby providing a growing cylindrical tube, severing the growing cylindrical tube to form a finished cylindrical tube, and separating the finished cylindrical tube from the second end of the forming mandrel.

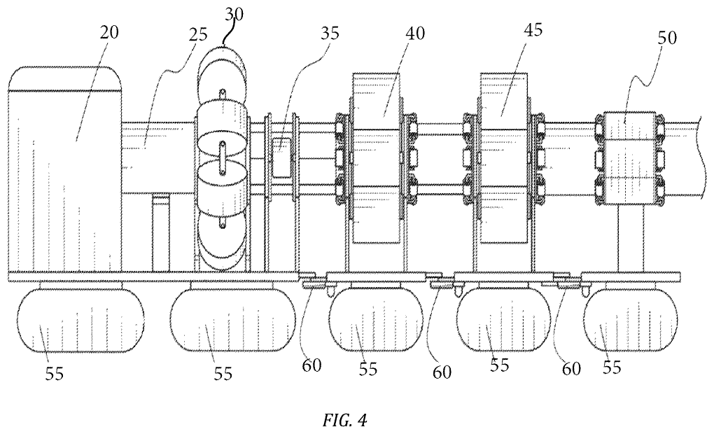

The forming mandrel used in the above method may be the same as or similar to the cantilevered forming mandrel shown in FIG. 4, which is an assembly for manufacturing a tubular composite described in detail in US Patent Application Publication No. 2022/0412511, the disclosure of which is incorporated herein in its entirety. As described in US Patent Application Publication No. 2022/0412511, assembly 20 includes a cantilevered forming mandrel 25 for forming a sealed tubular structure from flat feedstock, which may be the composite sheet stock as described herein. Assembly 20 also includes an axial reinforcement layer applicator 30, an orbital winder for a sensor array layer 35, an orbital winder for a hoop reinforcement layer 40, an orbital winder for a protective layer 45, an autoclave/coating applicator 50, articulating platforms 55 and hinges 60, each of which may or may not also be used in connection with the above-described method.

In addition, while a significant benefit of base layer 5 in combination with permeation resistant layer 10 is that permeation resistant layer 10 is impermeable to hydrogen or other gases, the present inventors have also discovered an additional, unexpected benefit and result of the combination of base layer 5 and permeation resistant layer 10. Specifically, the permeation resistant layer 10 adds significant additional strength and/or stiffness to a cylindrical tube formed from a composite sheet stock including base layer 5 and permeation resistant layer 10. In one embodiment, a base layer 5 made of M DPE is coextruded with a permeation resistant layer 10 made of a 7.5 mil (0.0075 inches) of metal or metal oxide foil. The coextruded foil adds significant structural strength and/or stiffness to the M DPE material. As noted above, in the production process of the disclosed concept, the materials are heated to form a cylindrical tube (such as a liner), and this additional strength/stiffness does not impede the forming process, and when cooled the physical properties of the material increase by a factor of 2x or better. As a result, it is possible to use nearly one half of the original thickness of the M DPE and still maintain the same hoop strength (of the M DPE) and buckling resistance (ring stiffness) of the formed cylindrical tube, making it lighter and less expensive while maintaining impermeability to hydrogen and other gases.

While the methods and manufactures have described in detail and with reference to specific examples thereof, it will be apparent to one skilled in the art that various changes and modifications can be made therein without departing from the spirit and scope thereof.

What is claimed is:

1. A composite sheet stock, comprising:
a base layer including a base material;
a permeation resistant layer including a permeation resistant material for providing resistance to leakage of gas through the composite sheet stock; and
a sacrificial/protective layer including a sacrificial material, wherein the permeation resistant layer is located between the base layer and the sacrificial/protective layer.

2. The composite sheet stock of claim 1, wherein the base material comprises a thermoplastic or thermoset material.

3. The composite sheet stock of claim 2, wherein the base material comprises a polyolefin or polyamide.

4. The composite sheet stock of claim 3, wherein the base material comprises a polyolefin, and wherein the polyolefin is chosen from polyethylene, polypropylene, or a mixture thereof.

5. The composite sheet stock of claim 4, wherein the base material comprises polyethylene.

6. The composite sheet stock of claim 5, wherein the polyethylene is chosen from HDPE, MDPE, or a mixture thereof.

7. The composite sheet stock of claim 3, wherein the base material comprises a polyamide, and wherein the polyamide is chosen from nylon and an aramid.

8. The composite sheet stock of claim 2, wherein the base material further comprises a metal oxide.

9. The composite sheet stock of claim 8, wherein the metal oxide is chosen from TiO₂ and Al₂O₃.

10. The composite sheet stock of claim 1, wherein a thickness of the base layer is between 0.060 inches and 6 inches, inclusive.

11. The composite sheet stock of claim 1, wherein the permeation resistant material is a foil.

12. The composite sheet stock of claim 11, wherein the foil comprises a metal, a metal oxide, or a mixture thereof.

13. The composite sheet stock of claim 12, wherein the foil comprises a metal and wherein the metal is chosen from aluminum, copper, gold, and molybdenum, or a mixture thereof.

14. The composite sheet stock of claim 12, wherein the foil comprises a metal and wherein the metal oxide is alumina.

15. The composite sheet stock of claim 1, wherein the permeation resistant material is coextruded with the base material.

16. The composite sheet stock of claim 1, wherein the permeation resistant material is bonded to the base material.

17. The composite sheet stock of claim 13, wherein the permeation resistant material is thermally bonded to the base material.

18. The composite sheet stock of claim 1, wherein a thickness of the permeation resistant layer is between 0.005 inches and 0.125 inches, inclusive.

19. The composite sheet stock of claim 1, wherein the sacrificial material comprises a thermoplastic or thermoset material.

20. The composite sheet stock of claim 19, wherein the sacrificial material comprises a polyolefin.

21. The composite sheet stock of claim 20, wherein the polyolefin is chosen from polyethylene, polypropylene, or a mixture thereof.

22. The composite sheet stock of claim 21, wherein the sacrificial material comprises MDPE.

23. The composite sheet stock of claim 1, wherein the thickness of the sacrificial/protective layer is between 0.020 inches and 0.050 inches, inclusive.

24. The composite sheet stock of claim 1, further comprising an external layer of abrasion or permeation resistant material on an external facing surface of the sacrificial/protective layer.

25. The composite sheet stock of claim 24, wherein the abrasion or permeation resistant material is a carbide.

26. The composite sheet stock of claim 25, wherein the abrasion or permeation resistant material is silicon carbide.

27. The composite sheet stock of claim 26, wherein the abrasion or permeation resistant material is beta-silicon carbide.

28. The composite sheet stock of claim 1, wherein:
the sheet stock is a rectangle with two long edges and two short edges.

29. The composite sheet stock of claim 28, wherein the base layer extends beyond the permeation resistant layer and, when present, the optional sacrificial/protective layer at the two long edges.

30. The composite sheet stock of claim 2, wherein:
the sheet stock is a rectangle with two long edges and two short edges.

31. The composite sheet stock of claim 30, wherein the base layer extends beyond the permeation resistant layer and the sacrificial/protective layer at the two long edges.

32. The composite sheet stock of claim 30, wherein the base layer extends between 0.060 inches and 0.125 inches, inclusive, at each of the two long edges.

33. A vessel for storing and/or transporting a gas, comprising:
a shell including a composite sheet stock comprising:
a base layer including a base material,
a permeation resistant layer including a permeation resistant material for providing resistance to leakage of gas through the sheet stock, and
a sacrificial/protective layer including a sacrificial material, wherein the permeation resistant layer is located between the base layer and the sacrificial/protective layer;
wherein the shell has an interior surface and an exterior surface, and wherein the base layer of the composite sheet stock is located on the exterior surface of the shell.

34. The vessel of claim 33, wherein the vessel is elongated in one dimension.

35. The vessel of claim 34, wherein the vessel is a cylindrical tube.

36. The vessel of claim 35, wherein
the vessel consists of a single strip of the composite sheet stock oriented lengthwise along a long axis of the vessel in a curved fashion such that a seem exists between two ends of the base layer and extends along a longitudinal axis of the vessel.

37. The vessel of claim 36, further comprising a weld that connects two ends of the base layer at the seam and extends along the longitudinal axis of the vessel.

38. The vessel of claim 37, wherein:
further comprising a channel extending along the longitudinal axis of the vessel in between the permeation resistant layer sacrificial/protective layer and over the weld.

39. The vessel of claim 38, wherein the channel is filled with a tape of viscous filler material.

40. The vessel of claim 39, wherein the tape comprises a material chosen from beta-silicon carbide, Al₂O₃, Al, Au, graphene, and Cu.

41. A method for manufacturing a cylindrical tube for storing and/or transporting a gas, comprising:
providing a feedstock of a composite sheet stock having first and second long ends extending in a longitudinal direction, the composite feed stock comprising:
a base layer comprising a base material,
a permeation resistant layer comprising a permeation resistant material for providing resistance to leakage of gas through the composite sheet stock, and
a sacrificial/protective layer comprising a sacrificial material;
wherein the permeation resistant layer is located between the base layer and the sacrificial/protective layer;
forming a circular leading end of the cylindrical tube from the composite sheet stock on a surface of a forming mandrel at a first location near a first end of the forming mandrel;
advancing the circular leading end towards a second end of the forming mandrel;
progressively draping the composite sheet stock onto the surface of the forming mandrel behind the advancing circular leading end so that the base layer is oriented on an exterior of the draped composite feed stock; and
progressively forming a seam between the first and second long ends along the longitudinal axis while the composite sheet stock is draped onto the surface of the forming mandrel.

42. The method of claim 41, further comprising
progressively welding the seam, thereby providing a growing cylindrical tube;
severing the growing cylindrical tube to form a finished cylindrical tube; and
separating the finished cylindrical tube from the second end of the forming mandrel.

43. The method of claim 41, wherein:
wherein a width of the base layer perpendicular to longitudinal direction is larger than width of the permeation resistant layer perpendicular to longitudinal direction and a width of the sacrificial/protective layer perpendicular to longitudinal direction such that a channel is formed between the permeation resistant layer and the permeation resistant layer along the longitudinal axis.

44. The method of claim 43, further comprising applying a tape of viscous filler material in the channel.

45. The method of claim 44, wherein the tape comprises a material chosen from beta-silicon carbide, Al₂O₃, Al, Au, graphene, and Cu.

46. The method of claim 41, wherein the forming mandrel is cantilevered.

47. The method of claim 46, wherein the first end of the forming mandrel is fixed and the second end of the forming mandrel is cantilevered.

48. The method of claim 41, further comprising heating the composite feed stock during the advancing, the progressively draping, and the progressively forming.

49. A method for manufacturing a cylindrical tube for storing and/or transporting a gas, comprising:
providing a feedstock of a composite sheet stock having first and second long ends extending in a longitudinal direction, the composite feed stock comprising:
a base layer comprising a base material,
a permeation resistant layer comprising a permeation resistant material for providing resistance to leakage of gas through the composite sheet stock,
forming a circular leading end of the cylindrical tube from the composite sheet stock on a surface of a forming mandrel at a first location near a first end of the forming mandrel;
advancing the circular leading end towards a second end of the forming mandrel;
progressively draping the composite sheet stock onto the surface of the forming mandrel behind the advancing circular leading end so that the base layer is oriented on an exterior of the draped composite feed stock; and
progressively forming a seam between the first and second long ends along the longitudinal axis while the composite sheet stock is draped onto the surface of the forming mandrel to form a cylindrical shape, wherein the permeation resistant layer is positioned inside the cylindrical shape.

50. The method of claim 49, further comprising
progressively welding the seam, thereby providing a growing cylindrical tube;
severing the growing cylindrical tube to form a finished cylindrical tube; and
separating the finished cylindrical tube from the second end of the forming mandrel, wherein the permeation resistant layer is positioned inside the finished cylindrical tube.

51. The method of claim 49, further comprising heating the composite feed stock during the advancing, the progressively draping and the progressively forming.

52. A vessel for storing and/or transporting a gas, comprising:
a tube structure including a composite sheet stock comprising:
a base layer including a base material, and
a permeation resistant layer including a permeation resistant material for providing resistance to leakage of gas through the sheet stock, and
wherein the tube structure has an interior surface and an exterior surface, and wherein the base layer of the composite sheet stock is located on the exterior surface of the tube structure.

53. The vessel of claim 52, wherein the composite sheet stock co-extruded composite sheet stock wherein the base layer is coupled to the permeation resistant layer by co-extrusion.

54. The vessel of claim 52, wherein the base material is a polyolefin and wherein the permeation resistant material includes a metal foil or a metal oxide foil.

55. The vessel of claim 54, wherein the polyolefin is M DPE and the foil is a metal foil.

56. The vessel of claim 55, wherein the metal foil is an aluminum foil, a copper foil, a gold foil, a molybdenum foil, or a mixture thereof.

57. The vessel of claim 54, wherein the polyolefin is M DPE and the foil is a metal oxide foil.

58. The vessel of claim 57, wherein the metal oxide foil is alumina.

59. The vessel of claim 54, wherein a thickness of the permeation resistant layer is between 0.005 inches and 0.125 inches, inclusive.

60. The vessel of claim 59, wherein a thickness of the permeation resistant layer is 0.0075 inches.

61. A method of forming a vessel for storing and/or transporting a gas, comprising:
creating a composite sheet stock including a base layer including a base material, wherein the base material is a polyolefin, and a permeation resistant layer including a permeation resistant material for providing resistance to leakage of gas through the sheet stock coupled to the base layer, wherein the permeation resistant material includes a metal foil or a metal oxide foil;
forming the composite sheet stock into a tube structure including heating the composite sheet stock, wherein the base material is located on an outer surface of the tube structure; and
cooling the tube structure.

62. The method of claim 61, wherein the creating comprises co-extruding the base layer and the permeation resistant layer.

63. The method of claim 61, wherein the polyolefin is M DPE and the foil is a metal foil.

64. The method of claim 63, wherein the metal foil is an aluminum foil, a copper foil, a gold foil, a molybdenum foil, or a mixture thereof.

65. The method of claim 61, wherein the polyolefin is M DPE and the foil is a metal oxide foil.

66. The method of claim 65, wherein the metal oxide foil is alumina.

67. The method of claim 61, wherein a thickness of the permeation resistant layer is between 0.005 inches and 0.125 inches, inclusive.

68. The method of claim 67, wherein a thickness of the permeation resistant layer is 0.0075 inches.
